(19) United States
(12) Patent Application Publication
(10) Pub. No.: US 2015/0102999 A1
(43) Pub. Date: Apr. 16, 2015

(54) DISPLAY APPARATUS

(71) Applicant: Industrial Technology Research Institute, Hsinchu (TW)

(72) Inventor: Chao-Hsu Tsai, Hsinchu City (TW)

(21) Appl. No.: 14/513,225

(22) Filed: Oct. 14, 2014

Related U.S. Application Data
(60) Provisional application No. 61/890,335, filed on Oct. 14, 2013.

(30) Foreign Application Priority Data
Aug. 26, 2014 (TW) 103129351

(51) Int. Cl. G02B 27/22; G06F 3/01; H04N 13/04; G02B 27/42

(52) U.S. Cl. CPC G02B 27/2214; G02B 27/4205; G06F 3/017; H04N 13/0468
USPC 345/156; 359/463

(57) ABSTRACT

A display apparatus including an image module and a micro deflecting array is provided. The image module is configured to provide a plurality of image beams, wherein these image beams contain a plurality sets of image information of different viewing angles, and the micro deflecting array is disposed on the transmission paths of these image beams. The micro deflecting array has a plurality of micro deflecting units arranged in an array, and these micro deflecting units are grouped into a plurality of micro deflecting groups interlaced with each other, and these micro deflecting groups respectively deflect these image beams to a plurality of directions, and a distribution range of azimuth angles of these directions, with respect to an optical axis of the micro deflecting array, in a direction perpendicular to the optical axis of the micro deflecting array occupies at least a part of 360 degrees.

### CROSS-REFERENCE TO RELATED APPLICATION

This application claims the priority benefits of U.S. provisional application Ser. No. 61/890,335, filed on Oct. 14, 2013 and Taiwan application serial no. 103129351, filed on Aug. 26, 2014. The entirety of each of the above-mentioned patent applications is hereby incorporated by reference herein and made a part of this specification.

### TECHNICAL FIELD

The technical field relates to a display apparatus.

### BACKGROUND

As the development of display technology advances, various needs for the display apparatus are increased during daily human life. In the current development of the display technology, stereoscopic display technique is one of the development mainstreams. In addition to bringing users with better visual experience, the stereoscopic display may allow the users to obtain more intuitions and more image information through interacting with stereoscopic images.

In the current stereoscopic display technology, stereoscopic display technique capable of forming a 360 degrees stereoscopic image is one of the development mainstreams. Some of the current 360 degrees stereoscopic display techniques are attained by a rotatable screen, and thus require mechanical components for rotating the screen. As a result, noises and vibrations are generated during the operation. The space swept by the screen during the rotation cannot be blocked by any object, and thus the rotation of the screen prohibits the user from touching the stereoscopic image displayed in the said space, thereby prohibiting the user from having more intuitive use experience. A stereoscopic display apparatus capable of providing a wide viewing angle (such as 360 degrees) and more favourable interaction effect is in need.

### SUMMARY

The embodiment of the disclosure provides a display apparatus including an image module and a micro deflecting array. The image module is configured to provide a plurality of image beams, wherein the image beams include a plurality of sets of image information of different viewing angles, and the micro deflecting array is disposed on transmission paths of the image beams. The micro deflecting array has a plurality of micro deflecting units arranged in an array, and these micro deflecting units are grouped into a plurality of micro deflecting groups interlaced with each other. These micro deflecting groups respectively deflect the image beams to a plurality of directions, and a distribution range of azimuth angles of the plurality of directions, with respect to an optical axis of the micro deflecting array, in a direction perpendicular to the optical axis occupies at least a part of 360 degrees.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a display apparatus according to a first embodiment of the disclosure.

FIG. 2 are a partial perspective view and a partial top view schematically illustrating the display apparatus of the first embodiment.

FIG. 3 is a schematic optical path diagram illustrating a display apparatus being observed along an optical axis of a micro deflecting array and towards the micro deflecting array according to an embodiment of the disclosure.

FIG. 4 is a schematic optical path diagram illustrating the display apparatus of the first embodiment being observed from the side.

FIG. 5 is a schematic diagram illustrating a micro deflecting array according to an embodiment of the disclosure.

FIG. 6A is a schematic diagram illustrating a display apparatus according to a second embodiment of the disclosure.

FIG. 6B is a schematic diagram illustrating a display apparatus according to another embodiment of the disclosure.

FIG. 7 is a schematic diagram illustrating a display apparatus according to a third embodiment of the disclosure.

FIG. 8 is a top view of deflections units in a third embodiment of the disclosure.

FIG. 9 is a schematic diagram illustrating parts of a display apparatus in the third embodiment of the disclosure.

FIG. 10 is a schematic diagram illustrating a display apparatus according to a fourth embodiment of the disclosure.

### DETAILED DESCRIPTION OF DISCLOSED EMBODIMENTS

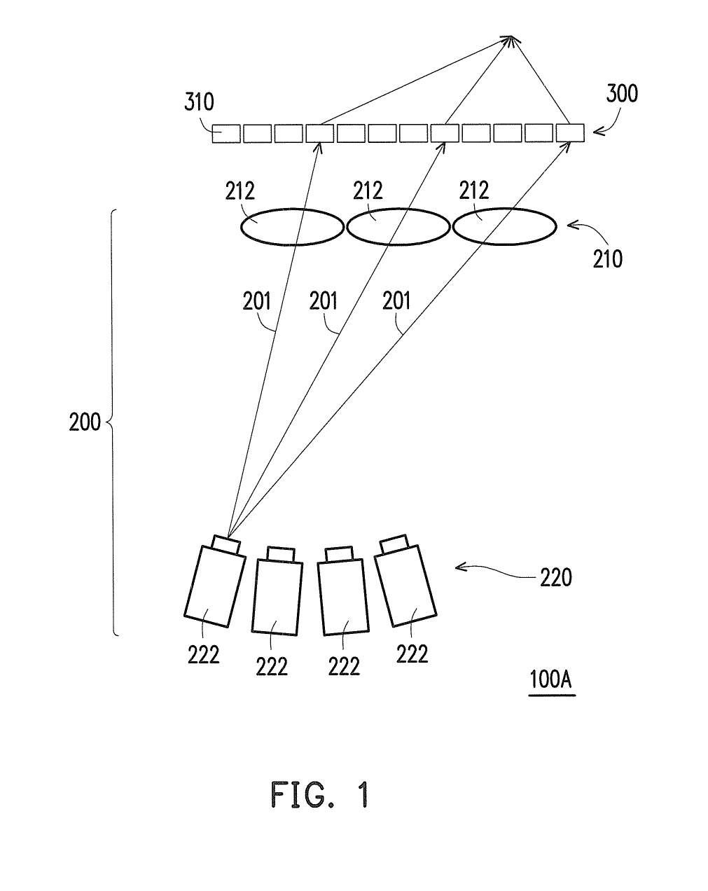

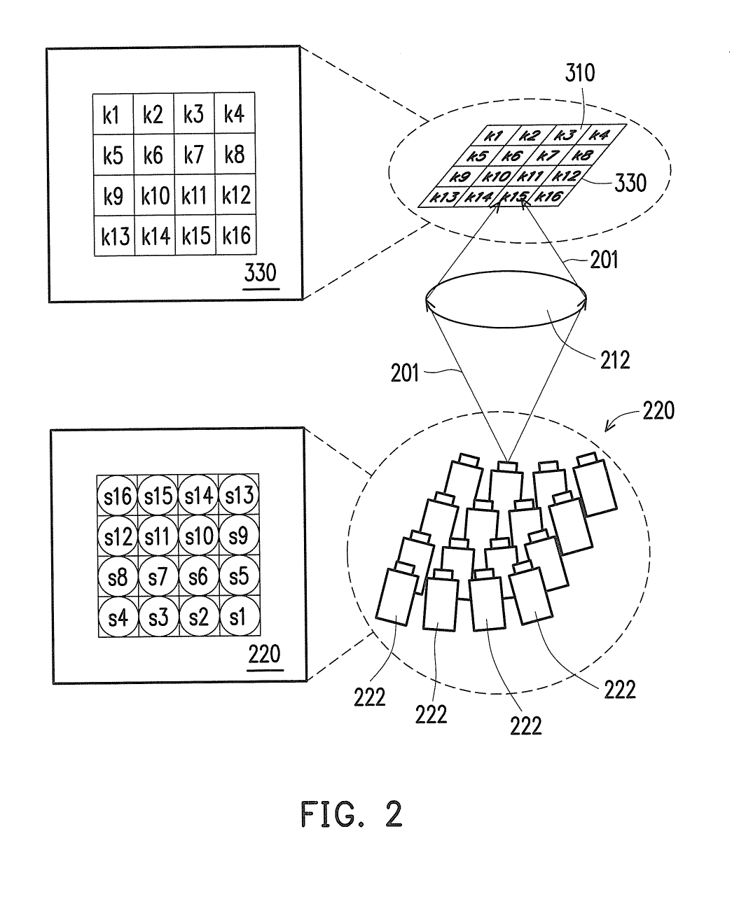

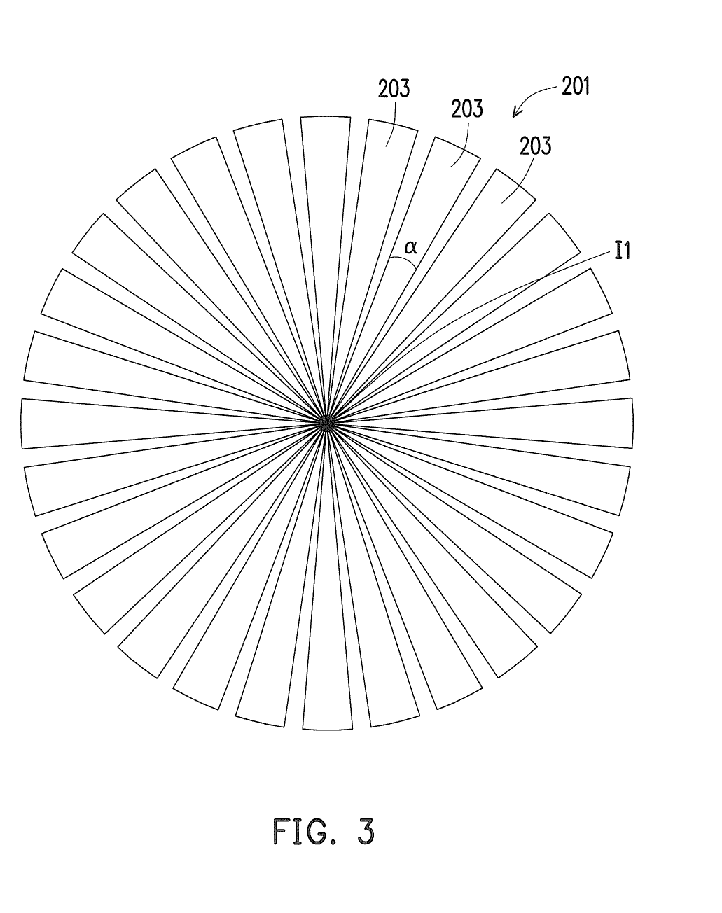

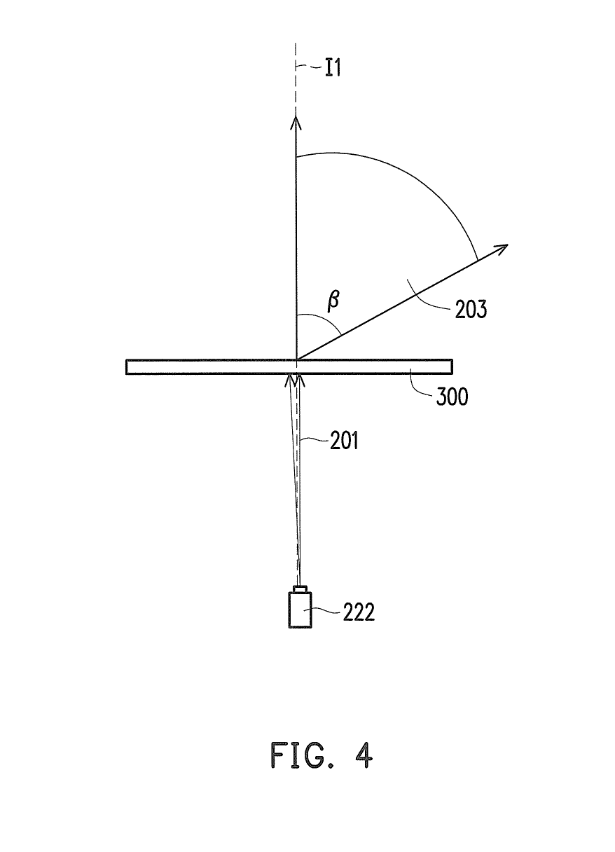

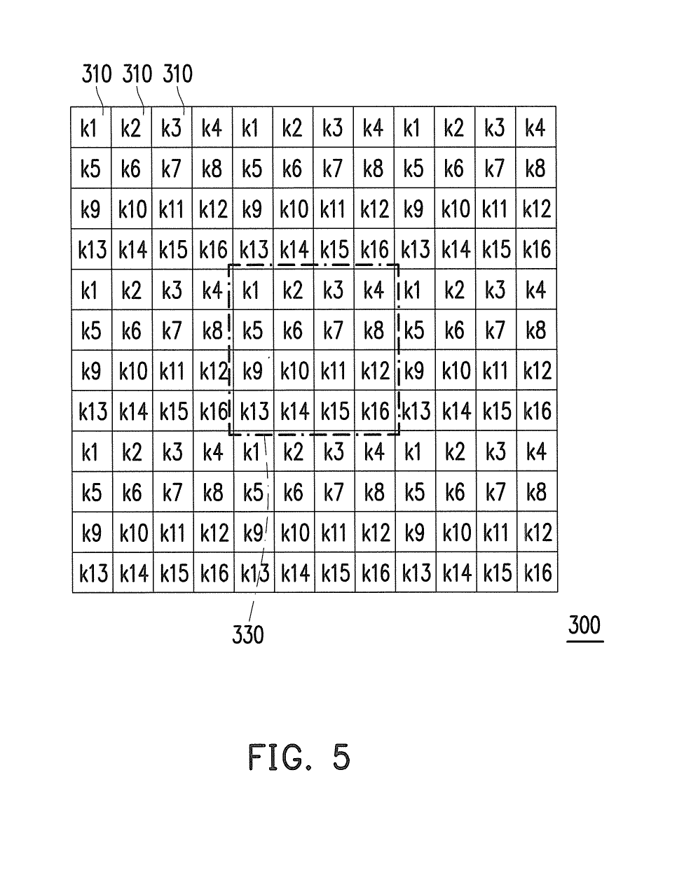

FIG. 1 is a schematic diagram illustrating a display apparatus according to a first embodiment of the disclosure. FIG. 2 are a partial perspective view and a partial top view schematically illustrating the display apparatus of the first embodiment. FIG. 3 is a schematic optical path diagram illustrating a display apparatus being observed along an optical axis of a micro deflecting array and towards the micro deflecting array according to the embodiment of the disclosure. FIG. 4 is a schematic optical path diagram illustrating the display apparatus of the first embodiment being observed from the side. FIG. 5 is a schematic diagram illustrating a micro deflecting array according to the embodiment of the disclosure. In order to clearly provide the details regarding a display apparatus 100A of the present embodiment of the disclosure, some components in the drawings of FIG. 1 and FIG. 2 are being enlarged, whereby the sizes and the locations thereof are not limited to the ones illustrated in the drawings. Referring to FIG. 1 through FIG. 5, in the embodiment, the display apparatus 100A includes an image module 200 and a micro deflecting array 300. The image module 200 may be configured to provide a plurality of image beams 201, wherein these image beams 201 include a plurality of sets of image information of different viewing angles, and the image module 200 includes a microlens array 210 and a projection module 220. The microlens array 210 has a plurality of microlenses 212 arranged in an array. The projection module 220 has a plurality of projection units 222, and these projection units 222 respectively emit the image beams 201. The micro deflecting array 300 is disposed on transmission paths of the image beams 201. The micro deflecting array 300 has a plurality of micro deflecting units 310 arranged in an array, and these micro deflecting units 310 are grouped into a plurality of micro deflecting groups k1 to k16, for example, interlaced with each other (please refer to FIG. 5). Referring to FIG. 5, in the present embodiment, in these micro deflecting units 310 (which are illustrated as a 12 by 12 array, with an amount of 144), the micro deflecting units 310 with label k1 thereon are grouped into a micro deflecting group k1, the micro deflecting units 310 with label k2 thereon are grouped into a micro deflecting group k2, and so forth; and for instance, there are a total of sixteen micro deflecting groups k1 to k16 in the present embodiment. The microlens array 210 is located between the projection module 220 and the micro deflecting array 300, and the microlenses 212 respectively guide the different image beams 201 to different micro deflecting groups k1 to k16. These micro deflecting groups k1 to k16 respectively deflect the image beams 201 to a plurality of directions, and a distribution range of azimuth angles of these directions in a direction perpendicular to an optical axis I1 of the micro deflecting array 300 occupies at least a part of 360 degrees.

Referring to FIG. 1 through FIG. 4, in the first embodiment of the disclosure, the micro deflecting groups k1 to k16 respectively deflect the image beams 201 to the plurality of directions, and these directions are arranged in a direction surrounding the optical axis I1 of the micro deflecting array 300 and axes parallel to the optical axis I1. In the present embodiment, the micro deflecting groups k1 to k16 respectively deflect the image beams 201 into a plurality of fan beams 203, for instance; and these fan beams 203 are emitted along the aforedescribed directions, for instance. In the present embodiment, different fan beams 203 will be received according to different positions of a user (namely, with respect to the difference in the direction of the optical axis I1) when the user views the display apparatus 100A, so as to provide the user a stereoscopic image. In the present embodiment, the micro deflecting groups k1 to k16 respectively form, for example, the plurality of fan beams 203, these fan beams 203 respectively has a large divergence angle β on one of the planes parallel to the optical axis I1, and these fan beams 203 respectively has a small divergence angle α on one of the planes perpendicular to the optical axis I1. In the present embodiment, the display apparatus 100A, in addition to providing a favorable stereoscopic image, may has a large viewing angle in the direction parallel to the optical axis I1. The display apparatus 100A in the first embodiment of the disclosure may provide a favorable floating stereoscopic image.

Referring to FIG. 3, in the first embodiment of the disclosure, the directions for projecting the fan beams 203 are arranged along a circular ring surrounding the optical axis I1 of the micro deflecting array 300 and axes parallel to the optical axis I1, but not limited thereto. In other embodiments, the directions for projecting the fan beams 203 may be arranged along a portion of a circular ring surround the optical axis I1 of the micro deflecting array 300 and axes parallel to the optical axis I1. In the first embodiment of the disclosure, the directions for projecting the fan beams 203 are arranged into 360 degrees surrounding the optical axis I1 of the micro deflection array 300 and the axes parallel to the optical axis I1, but not limited thereto. In other embodiments, the directions for projecting the fan beams 203 may further be arranged into 90 degrees, 120 degrees, 189 degrees or other proper degrees of a circular ring surrounding the optical axis I1 of the micro deflection array 300 and axes parallel to the optical axis I1.

Referring FIG. 5, FIG. 5 provides an exemplary arrangement method for the micro deflecting array 300 according to the embodiment of the disclosure, but is not intended for limiting the shape of each of the micro deflecting units 310, the number of micro deflecting units 310, and the arrangement method for the micro deflecting units 310. Referring to FIG. 1 and FIG. 5, In the first embodiment of the disclosure, the micro deflecting units 310 that are adjacent to each other while belonging to the different micro deflecting groups k1 to k16 respectively form a plurality of deflection units 330, each of the deflection units 330 has one of the micro deflecting units 310 from each of the micro deflecting groups k1 to k16, and a plurality parts of the image beams 201 respectively from the microlenses 212 are respectively transmitted to the deflection units 330 by the microlenses 212. In the image beams 201 emitted by the projection units 222, a part of the beams from any of the microlenses 212 is transmitted to the corresponding deflection unit 330.

Referring to FIG. 5, in the present embodiment, the micro deflecting units 310 are, for example, grouped into sixteen micro deflecting groups k1 to k16 (namely, these micro deflecting units 310 are grouped into k1 to k16 micro deflecting groups according to the labels shown in FIG. 5), and the deflection units 330 have one of the micro deflecting units 310 from each of the micro deflecting groups k1 to k16. In the present embodiment, the micro deflecting units 310 each, for example, is a refractive lens, a Fresnel lens, a diffraction grating or a diffractive optical element, but not limited thereto.

Each of the micro deflecting units 310 and each of the projection units 222 in the micro deflecting array 300 and the projection module 220 illustrated in FIG. 2 have corresponding relationships therebetween according to their respective labels; for instance, the image beam 201 emitted by the projection unit 222 with a label of s1 will arrive at the micro deflecting unit 310 with a micro deflecting group k1 after passing through the microlens array 210, and so forth. Referring to the top view of the micro deflecting array 300 and the projection module 220 illustrated in FIG. 2, in the first embodiment of the disclosure, the number of the projection units 222 equals to the number of the micro deflecting groups k1 to k16 (i.e., 16, and is arranged into a 4 by 4 matrix), and a direction of an order of arrangement for the projection units 222 and a direction of an order of arrangement for the corresponding micro deflecting units 310 in each of the deflection units 330 are off by 180 degrees. Referring to FIG. 2, in the present embodiment, viewing from a direction of the micro deflecting array 300 towards the projection module 220, when arranging the micro deflecting units 310 from the sixteen micro deflecting groups k1 to k16 in one deflection unit 330 by an order of from left-to-right and top-to-bottom, then the sixteen projection units 222 in the projection module 220 would be labelled as s1 to s16 starting from right-to-left and bottom-to-top. Referring to FIG. 1, FIG. 2 and FIG. 5, in the present embodiment, the image beams 201 emitted by the projection unit 222 with the label of s1 may arrive at the plurality of micro deflecting units 310 in the micro deflecting groups k1 after passing through the microlens array 210, and so forth; and the image beams 201 emitted by the other fifteen projection units 222 may respectively arrive at the micro deflecting groups k2 to k16 after passing through the microlens array 210.

In the first embodiment of the disclosure, the image beams 201 emitted by one of the projection units 222 in the projection module 220 may arrive at one of the micro deflecting groups k1 to k16 after passing through the microlens array 210, and the one of the micro deflecting groups k1 to k16 would then deflect the image beams 201 towards a same direction. In the present embodiment, the projection units 222, together with the micro deflecting groups k1 to k16, may enable the display apparatus 100A to have the image beams 201 from different projection unit 222 in each respective direction surrounding the micro deflecting array 300, thereby forming the favorable stereoscopic image.

In an embodiment of the disclosure, a distance between the microlens array 210 and the micro deflecting array 300 is greater than or smaller than a focal length of each of the microlenses 212. Since a light emitting end (e.g., a projection lens) of each of the projection units 222 (e.g., a projector) is, for example, circular in shape, the projection unit 222 has a diameter thereof; and thus a cross-section of the image beam 201 emitted by the light emitting end that is perpendicular to an optical axis of the said image beam 201 has an irradiated area, and by having the distance between the microlens array 210 and the micro deflecting array 300 being greater than or smaller than the focal length of each of the microlenses 212, the irradiated area of the image beam 201 when the said image beam 201 arrives at the micro deflecting array 300 may be close to a dimension of the micro deflecting units 310, thereby achieving the full use of the micro deflecting array 300. In the present embodiment, since the cross-section of the image beam 201 emitted by the light emitting end that is perpendicular to the optical axis thereof has a width, by having the distance between the microlens array 210 and the micro deflecting array 300 being greater than or smaller than the focal length of each of the microlenses 212, the width of the image beam 201 emitted by the light emitting end may also be appropriately adjusted.

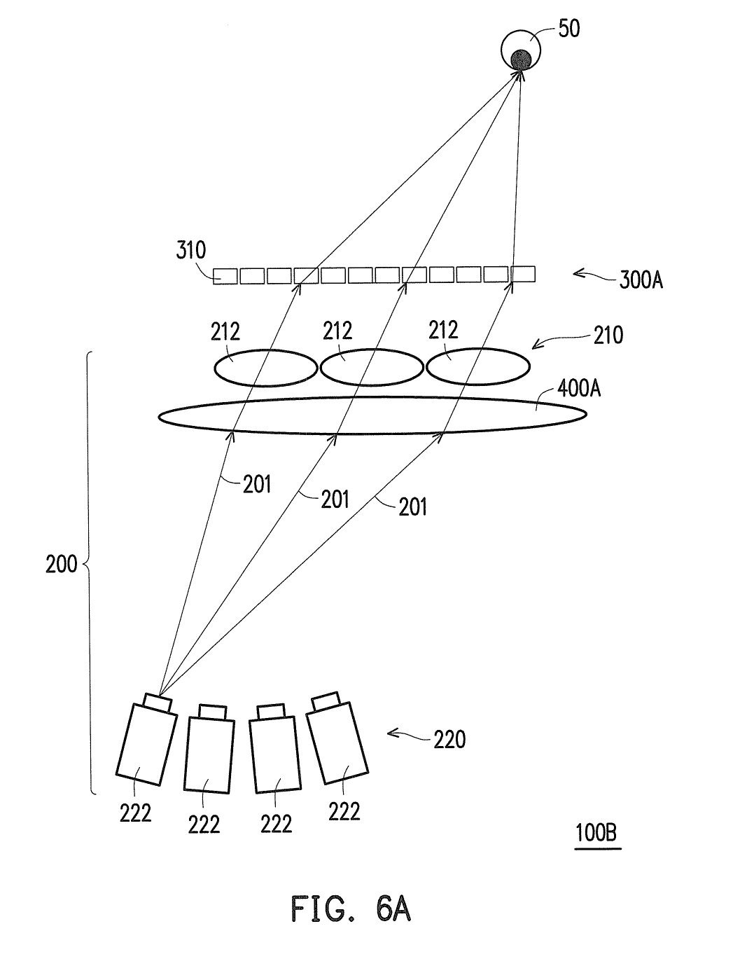

FIG. 6A is a schematic diagram illustrating a display apparatus according to a second embodiment of the disclosure. Referring to FIG. 6A, in the second embodiment of the disclosure, a display apparatus 100B is similar to the display apparatus 100A of the first embodiment, whereby a difference therebetween lies in that the display apparatus 100B further includes a lens 400A. The lens 400A is disposed on the transmission path of the image beams 201 and located between the microlens array 210 and the projection module 220. Referring to FIG. 5 and FIG. 6A, in the present embedment, a distance from the projection module 220 to the lens 400A equals a focal length of the lens 400A, and thus the image beams 201 may become parallel image beams 201 after being emitted by the projection module 220 and passing through the lens 400A, thereby enabling a cycle of the deflection units 330 and a cycle of the microlens array 210 to have the same period dimension; and since the micro deflecting units 310 in each of the micro deflecting array 300A have the same angle of incidence, these micro deflecting units may also be the same.

FIG. 6B is a schematic diagram illustrating a display apparatus according to another embodiment of the disclosure. Referring to FIG. 6A, in the second embodiment of the disclosure, a distance from the lens 400A to the projection module 220 is, for example, greater than the focal length of the lens 400A, but not limited thereto. Referring to FIG. 6B, in another embodiment of the disclosure, a distance between a lens 400B and the projection module 220 may be adjusted to be greater than a focal length of the lens 400B depending on difference in the light source or difference in the size of the microlens array 210. In an embodiment of the disclosure, the distance between the lens 400B and the projection module 220 is greater than the focal length of the lens 400B, so that the image beams 201 start to converge after passing through the lens 400B, the cycle of the deflection units 330 has to be a bit smaller than the cycle of the microlens array 210, and the micro deflecting units 310 in each of the micro deflecting groups gradually change to attain the best effect according to the angle of incidence of the image beams 201, but not limited thereto. In other embodiments, if the change in the angle of incidence of the image beams 201 is small, then the micro deflecting units 310 in each of the micro deflecting array 300B may also adopt the same design, so as to simplify the fabrication.

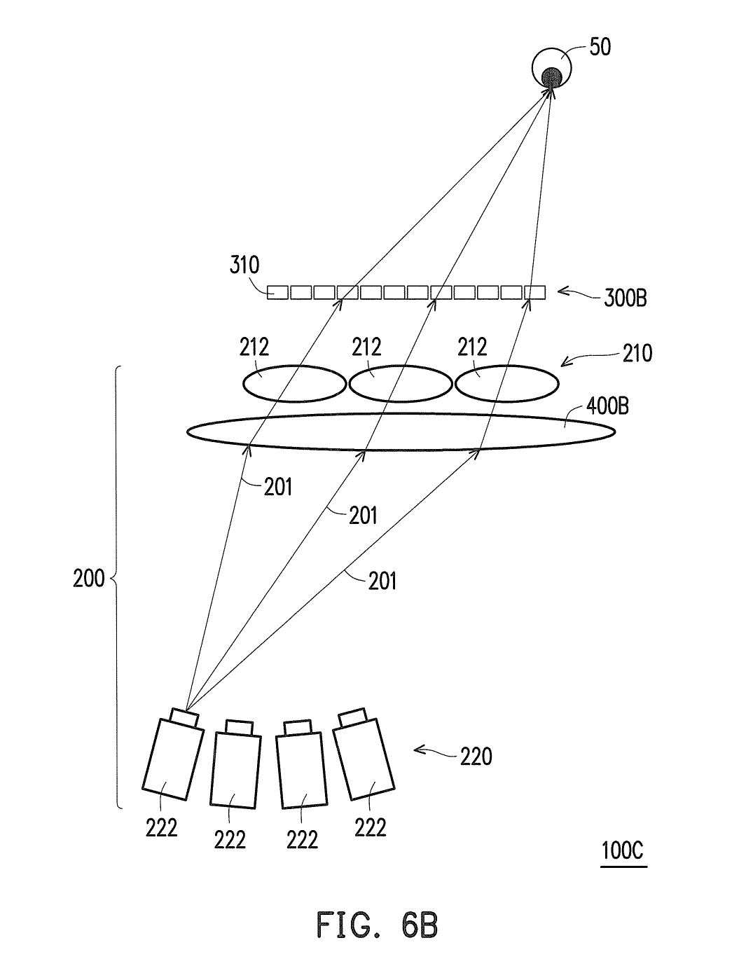

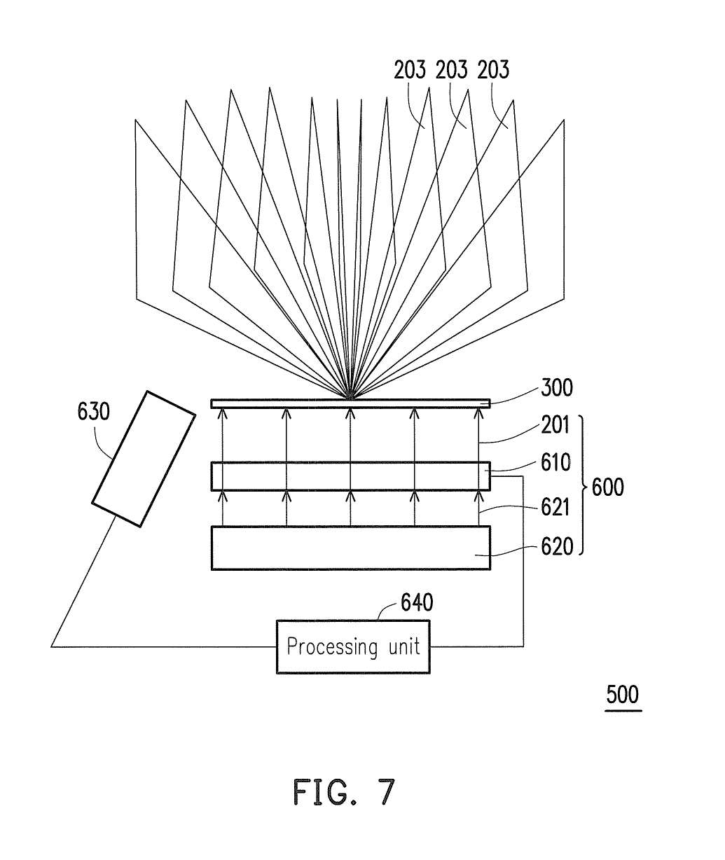

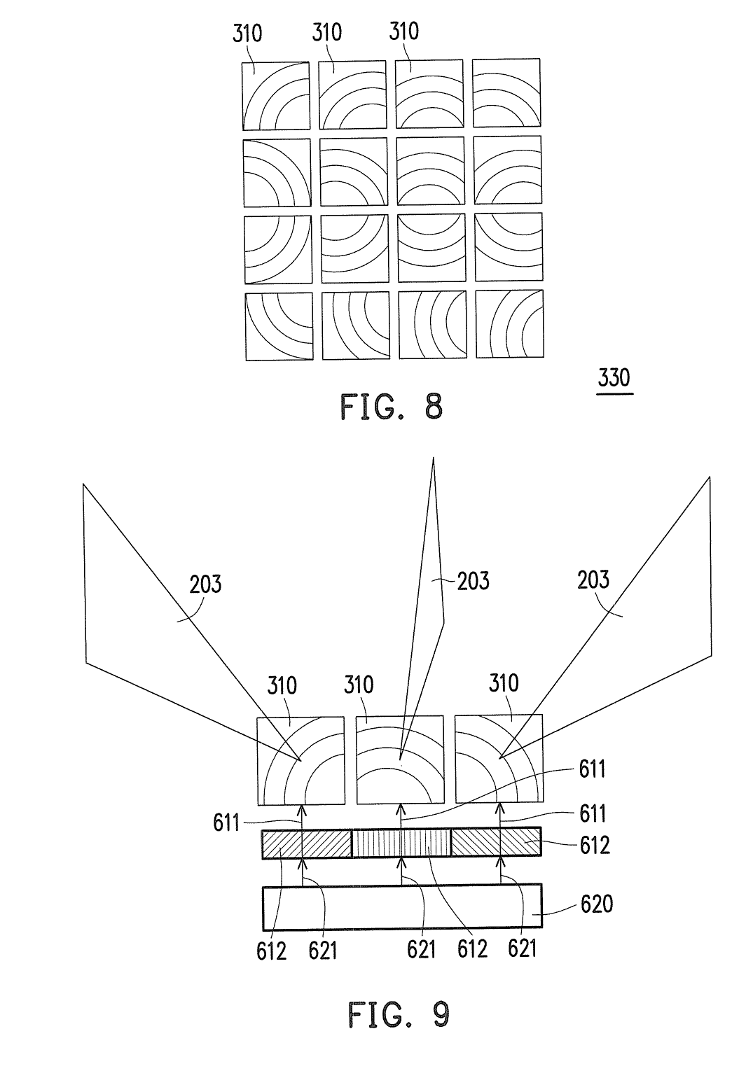

FIG. 7 is a schematic diagram illustrating a display apparatus according to a third embodiment of the disclosure. FIG. 8 is a top view of deflections units in the third embodiment of the disclosure. FIG. 9 is a schematic diagram illustrating parts of a display apparatus in the third embodiment of the disclosure. The micro deflecting array 300 of the embodiment illustrated in FIG. 7, FIG. 8 and FIG. 9 is similar to the micro deflecting array 300 of the previous embodiments, whereby a difference therebetween lies in that, the distribution of deflection directions of the micro deflecting units 310 in the deflection units 330 is herein illustrated with graphical symbols instead of the labels. Referring to FIG. 9, in the present embodiment, the beams, after passing through the micro deflecting units 310, are respectively deflected into a plurality of fan beams 203 according to a direction perpendicular to arc-lines illustrated on the micro deflecting units 310, wherein the arc-lines represent contour lines of a refractive element or micro-structure lines of a diffractive element. Referring to FIG. 7 and FIG. 8, in the third embodiment of the disclosure, a display apparatus 500 is similar to the display apparatus 100A of the previous embodiment, whereby a difference therebetween lies in that, an image module 600 of the present embodiment is different from the image module 200, such that the image module 600 includes a display element 610 and a collimated light source 620, and the collimated light source 620 collimatedly emits a collimated beam 621 to the display element 610. Referring to FIG. 5 and FIG. 7 through FIG. 9, the display element 610 has a plurality of display units 612. The display units 612 are grouped into a plurality of display unit groups interlaced with each other, the display unit groups respectively convert the collimated beams 621 into the image beams 201, and the display unit groups respectively correspond to the micro deflecting groups k1 to k16. The display units 612 in each of the display unit groups respectively correspond to the micro deflecting units 310 in their respective corresponding micro deflecting groups k1 to k16. Referring to FIG. 5, FIG. 7 and FIG. 9, in the present embodiment, an arrangement method for the display unit groups is the same as the arrangement method for the micro deflecting groups k1 to k16 illustrated in FIG. 5, the different display unit groups respectively emit the different image beams 201, and parts of the beams 611 from each of the display units 612 in the image beams 201 are collimatedly transmitted to the corresponding micro deflecting units 310. Refereeing to FIG. 5. FIG. 7 and FIG. 9, in the present embodiment, an arrangement method for the display units 612 in one of the display unit groups is the same as that of the micro deflecting units 310 being labelled with k1, as illustrated in FIG. 5, and the said display unit groups emit the image beams 201 according to an image corresponding to a direction, and so forth; and other fifteen display unit groups are respectively arranged according to the arrangement method for one of the micro deflecting units 310 being labelled with k2 to k16, and respectively emit the image beams 201 according to an image corresponding to a direction. In the third embodiment of the disclosure, parts of the beams 611 passing through the display unit groups are collimatedly transmitted to one of the micro deflecting groups k1 to k16, and the one of the micro deflecting groups k1 to k16 would transmit the parts of the beams 611 towards a direction. Therefore, combinations between the plurality of display unit groups and the plurality of micro deflecting groups k1 to k16 may transmit parts of the beams 611 of the different image beams 201 to a plurality of different directions, and azimuth angles of these directions in a direction perpendicular to the optical axis I1 of the micro deflecting array 300 are arranged in the direction surrounding the optical axis I1 of the micro deflecting array 300, thereby providing favorable stereoscopic image. In the present embodiment, the number of the display units 612 in each of the display unit groups may be the same.

Referring to FIG. 5, FIG. 7 and FIG. 8, in the present embodiment, the micro deflecting units 310 that are adjacent to each other while belonging to the different micro deflecting groups k1 to k16 are respectively grouped into the plurality of deflection units 330, wherein each of the deflection units 330 has one of the micro deflecting units 310 from each of the micro deflecting groups k1 to k16, the micro deflecting units 310 in each of the micro deflecting groups k1 to k16 are the same, and the micro deflecting units 310 in each of the deflection units 330 are different, but not limited thereto. In other embodiments, according to the needs, each of the micro deflecting groups k1 to k16 may be configured with different micro deflecting units 310 therein, and some of the micro deflecting units 310 in each of the deflection units 330 may be the same.

Referring to FIG. 7 and FIG. 9, in the present embodiment, display units 612 are, for example, sub-pixels of a display element 610, such as red sub-pixels, green sub-pixels or blue sub-pixels, and the numbers of the red sub-pixels, the green sub-pixels and the blue sub-pixels in each of the display unit groups are close. The red sub-pixels, the green sub-pixels and the blue sub-pixels are arranged in each of the display unit groups with an alternating order. The image beams 201 converted by the sub-pixels of each of the display unit groups may be projected towards a direction to compose a stereoscopic image for being viewed by a user located at the said direction. In other embodiments, the display units 612 may also be pixels of the display element 610, and each of the pixels includes a plurality of sub-pixels.

Referring to FIG. 7, in the present embodiment, a collimated light source 620 is, for example, a collimated backlight panel covering the display units 612.

Referring to FIG. 7, in the present embodiment, the display apparatus 500 further includes a sensing module 630 and a processing unit 640. The sensing module 630 is configured to sense an image of a user nearby the display apparatus 500. The processing unit 640 determines a motion of the user according to the image sensed by the sensing module 630 and outputs a command signal corresponding to the said motion to the display element 610. In the present embodiment, when the user performs a specific motion (such as a hand waving motion) nearby the display apparatus 500, the sensing module 630 may, for example, sense a dynamic image, and the processing unit 640 thus may determine, for example, the hand waving motion performed by the user or the speed and direction of the motion according to this dynamic image, and then output a command signal to the display element 610 for changing the image beams 201 being emitted thereby. In the present embodiment, the user may control the display apparatus 500 via body motions under the condition of not contacting the display apparatus 500.

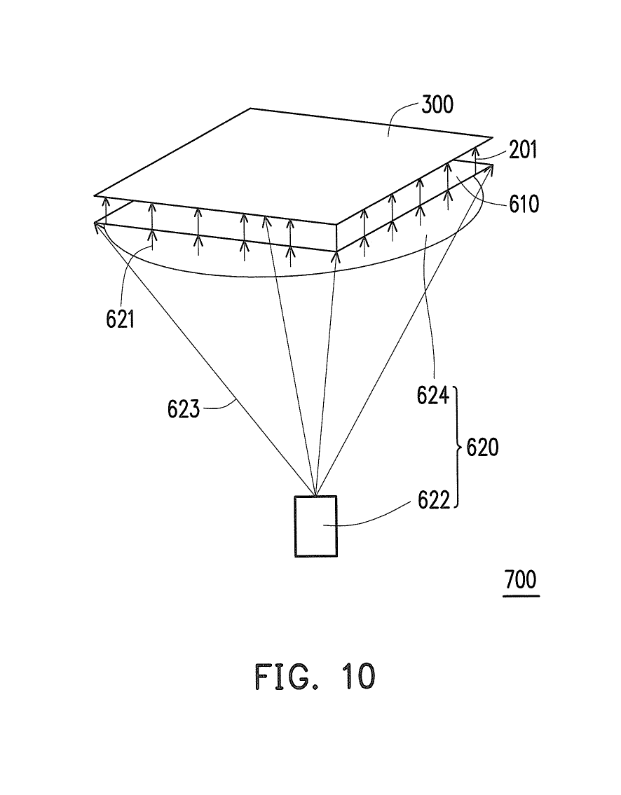

FIG. 10 is a schematic diagram illustrating a display apparatus according to a fourth embodiment of the disclosure. Referring to FIG. 10, a display apparatus 700 of the present embodiment is similar to the display apparatus 500 of the third embodiment, whereby a difference therebetween lies in that, the collimated light source 620 includes a light source 622 and a collimated lens 624. The light source 622 may be configured to emit a divergent beam 623, and the collimated lens 624 converges the divergent beam 623 into a collimated beam 621, wherein the light source 622 may be a point light source disposed at a focus position of the collimated lens 624. In the present embodiment, the divergent beam 623 is refracted into the collimated beam 621 via the collimated lens 624 in the collimated light source 620, and then the collimated beam 621 is provided to the display element 610.

The display apparatus provided in the embodiments of the disclosure may provide a plurality of different image beams via the image module, and together with the micro deflecting array on the transmission path of these image beams, may deflect the image beams related to different images to a plurality of directions, so as to enable the users view different stereoscopic images from different directions. When the user moves around the display apparatus provided in the embodiments of the disclosure, the stereoscopic image viewed by the user would be changed accordingly, thereby providing favorable floating stereoscopic image visual effect.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A display apparatus, comprising:
an image module, configured to provide a plurality of image beams, wherein the image beams contain a plurality sets of image information of different viewing angles; and
a micro deflecting array, disposed on transmission paths of the image beams, the micro deflecting array having a plurality of micro deflecting units arranged in an array, the micro deflecting units being grouped into a plurality of micro deflecting groups interlaced with each other, the micro deflecting groups respectively deflecting the image beams to a plurality of directions, and a distribution range of azimuth angles of the plurality of directions, with respect to an optical axis of the micro deflecting array, in a direction perpendicular to the optical axis occupying at least a part of 360 degrees.

2. The display apparatus as recited in claim 1, wherein the image module further comprises:
a microlens array, having a plurality of microlenses arranged in an array; and
a projection module, having a plurality of projection units configured to respectively emit the image beams, wherein the microlens array is disposed on the transmission paths of the image beams and located between the projection module and the micro deflecting array, and the microlenses respectively guide the different image beams to the different micro deflecting groups.

3. The display apparatus as recited in claim 2, wherein the micro deflecting units that are adjacent to each other while respectively belonging to the different micro deflecting groups respectively form a plurality of deflection units, each of the deflection units has one micro deflecting unit from each of the micro deflecting groups, and a plurality of parts of the image beams coming respectively from the microlenses are respectively transmitted to the deflection units by the microlenses.

4. The display apparatus as recited in claim 3, wherein a direction of an order of arrangement for the projection units and a direction of an order of arrangement for the corresponding micro deflecting units in each of the deflection units are off by 180 degrees.

5. The display apparatus as recited in claim 2, wherein the number of the projection units is equal to the number of the micro deflecting groups.

6. The display apparatus as recited in claim 2, wherein a distance between the microlens array and the micro deflecting array is greater than or smaller than a focal length of each of the microlenses.

7. The display apparatus as recited in claim 2, further comprising a lens disposed on the transmission paths of the image beams and located between the microlens array and the projection module.

8. The display apparatus as recited in claim 1, wherein the micro deflecting units are each a refractive lens or a diffraction grating.

9. The display apparatus as recited in claim 1, further comprising:
a sensing module, configured to sensing an image of a user nearby the display apparatus; and
a processing unit, configured to determine an action of the user according to the image sensed by the sensing module and output a command signal corresponding to the action to the image module.

10. The display apparatus as recited in claim 1, wherein the image module comprises a display element having a plurality of display units, the display units are grouped into a plurality of display unit groups interlaced with each other, and the different display unit groups respectively emit the different image beams.

11. The display apparatus as recited in claim 10, wherein the display unit groups respectively correspond to the micro deflecting groups, the display units in each of the display unit groups respectively correspond to the micro deflecting units in the respective corresponding micro deflecting group, and parts of the image beams from each of the display units are collimatedly transmitted to the respective corresponding micro deflecting unit.

12. The display apparatus as recited in claim 11, wherein the micro deflecting units that are adjacent to each other while respectively belonging to the different micro deflecting groups respectively form a plurality of deflection units, and each of the deflection units has one of the micro deflecting units from each of the micro deflecting groups.

13. The display apparatus as recited in claim 10, wherein the display unit is a pixel or a sub-pixel of the display element.

14. The display apparatus as recited in claim 10, wherein the image module further comprises a collimated light source collimatedly emitting a collimated beam to the display element, and the display unit groups respectively covert the collimated beams into to the image beams.

15. The display apparatus as recited in claim 14, wherein the collimated light source is a collimated backlight panel covering the display units.

16. The display apparatus as recited in claim 14, wherein the number of the display units belonging to each of the display unit group is the same.

17. The display apparatus as recited in claim 14, wherein the collimated light source comprises:
a light source configured to emit a divergent beam; and
a collimated lens converging the divergent beam into the collimated beam.

18. The display apparatus as recited in claim 17, wherein the light source is a point light source disposed at a focus position of the collimated lens.
